(19) United States
(12) Patent Application Publication
(10) Pub. No.: US 2008/0141937 A1
(43) Pub. Date: Jun. 19, 2008

(54) METHOD AND SYSTEM FOR CONTROLLING A VAPOR DELIVERY SYSTEM

(75) Inventor: Robert D. Clark, Guilderland, NY (US)

Correspondence Address: DLA PIPER US LLP, P. O. BOX 9271, RESTON, VA, 20195, US

(73) Assignee: TOKYO ELECTRON LIMITED, TOKYO (JP)

(21) Appl. No.: 11/612,580

(22) Filed: Dec. 19, 2006

(51) Int. Cl. B05C 5/00

(52) U.S. Cl. 118/697; 118/704; 427/255.23; 427/255.25

(57) ABSTRACT

A method and system is provided for determining and controlling the amount of film precursor vapor delivered to a substrate in a vapor deposition system, while maintaining a desired concentration of film precursor vapor within a carrier gas utilized to transport the film precursor vapor. The vapor deposition system comprises a vapor delivery system comprising a carrier gas supply system configured to supply a first flow of carrier gas that passes through a precursor evaporation system to entrain film precursor vapor and to supply a second flow of carrier gas that by-passes the precursor evaporation system. The vapor delivery system comprises a carrier gas flow control system to control the amount of the first flow of the carrier gas and control the amount of the second flow of the carrier gas. Additionally, the vapor delivery system comprises a film precursor vapor flow measurement system configured to measure an amount of the film precursor vapor introduced to the first flow of the carrier gas. Furthermore, a controller is configured to to compare the measured amount of the film precursor vapor to a target amount, to adjust the amount of the first flow of carrier gas such that the measured amount of the film precursor vapor is substantially equal to the target amount, and to adjust the amount of the second flow of the carrier gas such that the total amount of the first flow and second flow of carrier achieves a desired value.

### BACKGROUND OF THE INVENTION

1. Field of Invention

The present invention relates to a method and system for controlling a film precursor in a vapor deposition system.

2. Description of Related Art

During fabrication of an integrated circuit (IC), various materials are formed on and removed from the IC at various steps amongst a sequence of many steps utilized to produce the IC. For example, (dry) plasma etching is often used to remove or etch material along fine lines or within vias or contacts patterned on a substrate for production of many ICs. Alternatively, for example, vapor deposition processes are often used to form or deposit a material film along fine lines or within vias or contacts on the substrate. Such vapor deposition processes include chemical vapor deposition (CVD) and plasma enhanced chemical vapor deposition (PECVD) for gate dielectric film formation in front-end-of-line (FEOL) operations, and barrier layer and seed layer formation for metallization in back-end-of-line (BEOL) operations, as well as capacitor dielectric film formation in DRAM production.

In a CVD process, a continuous stream of film precursor vapor is introduced to a process chamber containing a substrate, wherein the composition of the film precursor has the principal atomic or molecular species found in the film to be formed on the substrate. During this continuous process, the precursor vapor is chemisorbed on the surface of the substrate while it thermally decomposes and reacts with or without the presence of an additional gaseous component that assists the reduction of the chemisorbed material, thus, leaving behind the desired film.

In a PECVD process, the CVD process further includes plasma that is utilized to alter or enhance the film deposition mechanism. For instance, plasma excitation generally allows film-forming reactions to proceed at temperatures that are significantly lower than those typically required to produce a similar film by thermally excited CVD. In addition, plasma excitation may activate film-forming chemical reactions that are not energetically or kinetically favored in thermal CVD.

More recently, atomic layer deposition (ALD), as well as plasma enhanced ALD (PEALD), have emerged as candidates for both FEOL and BEOL operations. In an ALD process, separate pulses of precursor vapor are introduced to a process chamber containing the substrate, where the pulses can be separated by either purging or evacuating. During each pulse, a self-limited chemisorbed layer is formed on the surface of the substrate, which layer then reacts with the gaseous components introduced in the next pulse. Purging or evacuation between each pulse may be used to reduce or eliminate gas phase mixing of the sequentially introduced gaseous components. The typical ALD process results in well-controlled sub-monolayer or near monolayer growth per cycle.

At present, many CVD and ALD processes contemplate the use of solid precursors, whereby the precursor vapor is derived from the sublimation of a solid-phase material. For example, when depositing transition metals such as tantalum (Ta), tungsten (W), ruthenium (Ru), rhodium (Rh), etc., solid-phase metal carbonyls (e.g., W(CO)₆, Ru₃(CO)₁₂, etc.) are considered as film precursors.

### SUMMARY OF THE INVENTION

The present invention relates to a method and system for delivering a film precursor to a substrate in a vapor deposition system.

According to one embodiment, a method of, and computer-readable medium for, controlling a film precursor vapor in a vapor deposition system is described. A first flow of a carrier gas is initiated through a precursor evaporation system. The film precursor vapor is introduced to the first flow of the carrier gas in the precursor evaporation system. A second flow of the carrier gas is initiated that by-passes the precursor evaporation system. An amount, flow rate, partial pressure, concentration, or any combination thereof (collectively referred to throughout this patent as “amount”) of the film precursor vapor introduced to the first flow of the carrier gas is measured. The amount of the film precursor vapor is compared to a target amount of the film precursor vapor. The first flow of the carrier gas through the precursor evaporation system is adjusted such that the measured amount of the film precursor vapor is substantially equal to the target amount of the film precursor vapor. The second flow of the carrier gas is adjusted such that a total amount of the first flow of the carrier gas and the second flow of the carrier gas remains substantially constant. The first flow of the carrier gas with the film precursor vapor, and the second flow of the carrier gas is introduced to the vapor deposition system.

According to another embodiment, a vapor delivery system configured to be coupled to a vapor deposition system and configured to introduce a film precursor vapor to a substrate within the vapor deposition system in order to form a thin film on the substrate from the film precursor vapor is described. A precursor evaporation system is configured to evaporate a film precursor to form the film precursor vapor. A carrier gas supply system is coupled to the process chamber and the precursor evaporation system, wherein the carrier gas supply system is configured to introduce a first flow of a carrier gas to the process chamber that passes through the precursor evaporation system and receives the film precursor vapor. The carrier gas supply system is configured to introduce a second flow of the carrier gas to the process chamber through a by-pass gas line that by-passes the precursor evaporation system. A carrier gas flow control system is coupled to an output of the carrier gas supply system, and is configured to control the amount of the first flow of the carrier gas and control the amount of the second flow of the carrier gas. A film precursor vapor flow measurement system is coupled to an inlet of the precursor evaporation system and an outlet of the precursor evaporation system, and is configured to measure an amount of the film precursor vapor introduced to the first flow of the carrier gas. A controller is coupled to the carrier gas flow control system and the film precursor vapor flow measurement system, wherein the controller is configured to compare the measured amount of the film precursor vapor to a target amount of the film precursor vapor. The controller is also configured to adjust the amount of the first flow of the carrier gas such that the measured amount of the film precursor vapor is substantially equal to the target amount of the film precursor vapor. Also the controller is configured to adjust the amount of the second flow of the carrier gas such that the total amount of the first flow of the carrier gas and the second flow of the carrier gas achieves a predetermined value.

According to yet another embodiment, a method of controlling a film precursor vapor in a vapor deposition system is described. A first flow of a carrier gas is initiated through a precursor evaporation system. The film precursor vapor is introduced to the first flow of the carrier gas in the precursor evaporation system. A second flow of the carrier gas is initiated that by-passes the precursor evaporation system; measuring an amount of the film precursor vapor introduced to the first flow of the carrier gas. The amount of the film precursor vapor is compared to a target amount of the film precursor vapor. The first flow of the carrier gas through the precursor evaporation system is adjusted such that the measured amount of the film precursor vapor is substantially equal to the target amount of the film precursor vapor. The second flow of the carrier gas is adjusted such that the total amount of the first flow of the carrier gas and the second flow of the carrier gas is substantially equal to a target amount. The first flow of the carrier gas with the film precursor vapor and the second flow of the carrier gas is introduced to the vapor deposition system.

### BRIEF DESCRIPTION OF THE DRAWINGS

In the accompanying drawings:

FIG. 1 illustrates a system for delivering film precursor vapor to a substrate in a vapor deposition system according to an embodiment;

FIG. 2 illustrates a system for delivering film precursor vapor to a substrate in a vapor deposition system according to another embodiment;

FIG. 3 illustrates a system for delivering film precursor vapor to a substrate in a vapor deposition system according to another embodiment; and

FIG. 4 provides a method of determining an amount of film precursor vapor delivered to a substrate in a vapor deposition system according to yet another embodiment.

### DETAILED DESCRIPTION OF SEVERAL EMBODIMENTS

In the following description, in order to facilitate a thorough understanding of the invention and for purposes of explanation and not limitation, specific details are set forth, such as a particular geometry of the deposition system and descriptions of various components. However, it should be understood that the invention may be practiced in other embodiments that depart from these specific details.

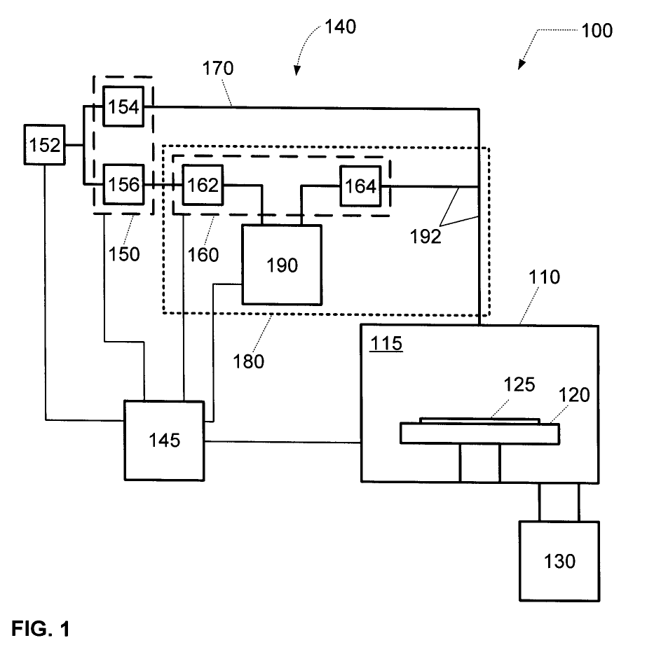

Referring now to the drawings, wherein like reference numerals designate identical or corresponding parts throughout the several views, FIG. 1 illustrates a vapor deposition system 100 for depositing a thin film, such as a metal film or a metal-containing film. The thin film may include materials suitable for use as seed layers or barrier layers in the metallization of inter-/intra-connect structures in electronic devices; materials suitable for use as gate dielectrics in electronic devices; materials suitable for use as capacitor dielectrics in DRAM devices, or the like. For example, the thin film may include a metal, metal oxide, metal nitride, metal oxynitride, metal silicate, metal silicide, etc. The deposition system 100 may include any vapor deposition system configured to form a thin film from a film precursor vapor including, but not limited to: a chemical vapor deposition (CVD) system, a plasma-enhanced CVD (PECVD) system, an atomic layer deposition (ALD) system, a plasma-enhanced ALD (PEALD) system, etc.

The vapor deposition system 100 comprises a process chamber 110 having a substrate holder 120 configured to support a substrate 125, upon which the thin film is formed, and heat the substrate 125. The process chamber 110 is configured to receive a film precursor vapor in process space 115 from a vapor delivery system 140. Additionally, the process chamber 110 may include a vapor distribution system (not shown) configured to distribute the film precursor vapor within process space 115 above substrate 125.

Furthermore, the process chamber 110 is coupled to a vacuum pumping system 130 through a duct, wherein the pumping system 130 is configured to evacuate the process chamber 110 and the vapor delivery system 140 to a pressure suitable for forming the thin film on the substrate 125 and suitable for evaporation (or sublimation) of the film precursor in the vapor delivery system 140.

The vapor delivery system 140 comprises a precursor evaporation system 190 configured to store a film precursor, and heat the film precursor to a temperature sufficient for evaporating the film precursor, while introducing film precursor vapor to the process chamber 110 through a vapor delivery line 192. For example, the precursor evaporation system 190 can include a (conventional) single-tray ampoule, or it may include a multi-tray ampoule, such as the ampoule described in pending U.S. patent application Ser. No. 10/998,420, entitled “MULTI-TRAY FILM PRECURSOR EVAPORATION SYSTEM AND THIN FILM DEPOSITION SYSTEM INCORPORATING THE SAME” and filed on Nov. 29, 2004; the contents of which are herein incorporated by reference in their entirety. The film precursor can, for example, comprise a solid-phase film precursor. Alternatively, for example, the film precursor can comprise a liquid-phase film precursor. The terms “vaporization,” “sublimation” and “evaporation” are used interchangeably herein to refer to the general formation of a vapor (gas) from a solid or liquid precursor, regardless of whether the transformation is, for example, from solid to liquid to gas, solid to gas, or liquid to gas.

Moreover, the film precursor may include a metal precursor. Further yet, the metal precursor may include a metal-carbonyl. For instance, the metal carbonyl precursor can have the general formula Mₓ(CO)_{y}, and can comprise a tungsten carbonyl, a nickel carbonyl, a molybdenum carbonyl, a cobalt carbonyl, a rhodium carbonyl, a rhenium carbonyl, a ruthenium carbonyl, a chromium carbonyl, or an osmium carbonyl, or a combination of two or more thereof. These metal carbonyls include, but are not limited to, W(CO)₆, Ni(CO)₄, Mo(CO)₆, Co₂(CO)₈, Rh₄(CO)₁₂, Re₂(CO)₁₀, Cr(CO)₆, Ru₃(CO)₁₂, or Os₃(CO)₁₂, or a combination of two or more thereof.

Other vapor deposition processes and other film precursors are also possible including, but not limited to, the following:

In one example, a vapor deposition process can be used be to deposit tantalum (Ta), tantalum carbide, tantalum nitride, or tantalum carbonitride in which a Ta film precursor such as TaF₅, TaCl₅, TaBr₅, Tal₅, Ta(CO)₅, Ta[N(C₂H₅CH₃)]₅ (PEMAT), Ta[N(CH₃)₂]₅ (PDMAT), Ta[N(C₂H₅)₂]₅ (PDEAT), Ta(NC(CH₃)₃)(N(C₂H₅)₂)₃ (TBTDET), Ta(NC₂H₅)(N(C₂H₅)₂)₃, Ta(NC(CH₃)₂C₂H₅)(N(CH₃)₂)₃, or Ta(NC(CH₃)₃)(N(CH₃)₂)₃, adsorbs to the surface of the substrate followed by exposure to a reduction gas or plasma such as H₂, NH₃, N₂ and H₂, N₂H₄, NH(CH₃)₂, or N₂H₃CH₃.

In another example, titanium (Ti), titanium nitride, or titanium carbonitride can be deposited using a Ti precursor such as TiF₄, TiCl₄, TiBr₄, Til₄, Ti[N(C₂H₅CH₃)]₄ (TEMAT), Ti[N(CH₃)₂]₄ (TDMAT), or Ti[N(C₂H₅)₂]₄ (TDEAT), and a reduction gas or plasma including H₂, NH₃, N₂ and H₂, N₂H₄, NH(CH₃)₂, or N₂H₃CH₃.

In another example, tungsten (W), tungsten nitride, or tungsten carbonitride can be deposited using a W precursor such as WF₆, or W(CO)₆, and a reduction gas or plasma including H₂, NH₃, N₂ and H₂, N₂H₄, NH(CH₃)₂, or N₂H₃CH₃.

In yet another example, when depositing hafnium oxide, the Hf precursor can include Hf(OBu^{t})₄, Hf(NO₃)₄, or HfCl₄, and the reduction gas may include H₂O. In another example, when depositing hafnium (Hf), the Hf precursor can include HfCl₄, and an optional reduction gas may include H₂.

In yet another example, when depositing a silicon-containing film, the silicon precursor can include silane (SiH₄), disilane (Si₂H₆), monochlorosilane (SiClH₃), dichlorosilane (SiH₂Cl₂), trichlorosilane (SiHCl₃), hexachlorodisilane (Si₂Cl₆), tetrakis(dimethylamino)silane (TDMAS), tris(dimethylamino)silane (TrDMAS), Diethylsilane (Et₂SiH₂), tetrakis(ethylmethylamino)silane (TEMAS), bis(diethylamino)silane, bis(di-isopropylamino)silane (BIPAS), tris(isopropylamino)silane (TIPAS), and (di-isopropylamino)silane (DIPAS).

In yet another example, when depositing a film containing an alkaline earth metal, the alkaline earth precursor can have the formula:

ML¹L²Dₓ

where M is an alkaline earth metal element selected from the group of beryllium (Be), magnesium (Mg), calcium (Ca), strontium (Sr), and barium (Ba). L¹ and L² are individual anionic ligands, and D is a neutral donor ligand where x can be 0, 1, 2, or 3. Each L¹, L² ligand may be individually selected from the groups of alkoxides, halides, aryloxides, amides, cyclopentadienyls, alkyls, silyls, amidinates, β-diketonates, ketoiminates, silanoates, and carboxylates. D ligands may be selected from groups of ethers, furans, pyridines, pyroles, pyrolidines, amines, crown ethers, glymes, and nitriles.

Examples of L group alkoxides include tert-butoxide, iso-propoxide, ethoxide, 1-methoxy-2,2-dimethyl-2-propionate (mmp), 1-dimethylamino-2,2′-dimethyl-propionate, amyloxide, neo-pentoxide or the like. Examples of halides include fluoride, chloride, iodide, or bromide. Examples of aryloxides include phenoxide, 2,4,6-trimethylphenoxide or the like. Examples of amides include bis(trimethylsilyl)amide di-tert-butylamide, 2,2,6,6-tetramethylpiperidide (TMPD) or the like. Examples of cyclepentadienyls include cyclopentadienyl, 1-methylcyclopentadienyl, 1,2,3,4-tetramethylcyclopentadienyl, 1-ethylcyclopentadienyl, pentamethylcyclopentadienyl, 1-iso-propylcyclopentadienyl, 1-n-propylcyclopentadienyl, 1-n-butylcyclopentadienyl or the like. Examples of alkyls include bis(trimethylsilyl)methyl, tris(trimethylsilyl)methyl, trimethylsilylmethyl or the like. Examples of silyls include trimethylsilyl or the like. Examples of amidinates include N,N′-di-tert-butylacetamidinate, N,N′-di-iso-propylacetamidinate, N,N′-di-isopropyl-2-tert-butylamidinate, N,N′-di-tert-butyl-2-tert-butylamidinate or the like. Examples of β-diketonates include 2,2,6,6-tetramethyl-3,5-heptanedionate (THD), hexafluoro-2,4-pentanedionate (hfac), 6,6,7,7,8,8,8-heptafluoro-2,2-dimethyl-3,5-octanedionate (FOD) or the like. Examples of ketoiminates include 2-iso-propylimino-4-pentanonate or the like. Examples of silanoates include tri-tert-butylsiloxide, triethylsiloxide or the like. Examples of carboxylates include 2-ethylhexanoate or the like.

Examples of D ligands include tetrahydrofuran, diethylether, 1,2-dimethoxyethane, diglyme, triglyme, tetraglyme, 12-Crown-6, 10-Crown-4, pyridine, N-methylpyrolidine, triethylamine, trimethylamine, acetonitrile, 2,2-dimethylpropionitrile or the like.

Representative examples of alkaline earth precursors include:

Be precursors: Be(N(SiMe₃)₂)₂, Be(TMPD)₂, or BeEt₂ or combinations of two or more thereof.

Mg precursors: Mg(N(SiMe₃)₂)₂, Mg(TMPD)₂, Mg(PrCp)₂, Mg(EtCp)₂, or MgCp₂ or combinations of two or more thereof.

Ca precursors: Ca(N(SiMe₃)₂)₂, Ca(iPr₄Cp)₂, or Ca(Me₅Cp)₂ or combinations of two or more thereof.

Sr precursors: Bis(tert-butylacetamidinato)strontium (TBAASr), Sr—C, Sr-D, Sr(N(SiMe₃)₂)₂, Sr(THD)₂, Sr(THD)₂(tetraglyme), Sr(iPr₄Cp)₂, Sr(iPr₃Cp)₂, or Sr(Me₅Cp)₂ or combinations of two or more thereof.

Ba precursors: Bis(tert-butylacetamidinato)barium (TBAABa), Ba—C, Ba-D, Ba(N(SiMe₃)₂)₂, Ba(THD)₂, Ba(THD)₂(tetraglyme), Ba(iPr₄Cp)₂, Ba(Me₅Cp)₂, or Ba(nPrMe₄Cp)₂ or combinations of two or more thereof.

In yet another example, when depositing a film containing a Group IVB element, the Group IVB precursor can include: Hf(O^{t}Bu)₄ (hafnium tert-butoxide, HTB), Hf(NEt₂)₄ (tetrakis(diethylamido)hafnium, TDEAH), Hf(NEtMe)₄ (tetrakis(ethylmethylamido)hafnium, TEMAH), Hf(NMe₂)₄ (tetrakis(dimethylamido)hafnium, TDMAH), Zr(O^{t}Bu)₄ (zirconium tert-butoxide, ZTB), Zr(NEt₂)₄ (tetrakis(diethylamido)zirconium, TDEAZ), Zr(NMeEt)₄ (tetrakis(ethylmethylamido)zirconium, TEMAZ), Zr(NMe₂)₄ (tetrakis(dimethylamido)zirconium, TDMAZ), Hf(mmp)₄, Zr(mmp)₄, Ti(mmp)₄, HfCl₄, ZrCl₄, TiCl₄, Ti(NiPr₂)₄, Ti(NiPr₂)₃, tris(N,N′-dimethylacetamidinato)titanium, ZrCp₂Me₂, Zr(tBuCp)₂Me₂, Zr(NiPr₂)₄, Ti(OiPr)₄, Ti(O^{t}Bu)₄ (titanium tert-butoxide, TTB), Ti(NEt₂)₄ (tetrakis(diethylamido)titanium, TDEAT), Ti(NMeEt)₄ (tetrakis(ethylmethylamido)titanium, TEMAT), Ti(NMe₂)₄ (tetrakis(dimethylamido)titanium, TDMAT), Ti(THD)₃ (tris(2,2,6,6-tetramethyl-3,5-heptanedionato)titanium) or the like.

In yet another example, when depositing a film containing a Group VB element, the Group VB precursor can include: Ta(NMe₂)₅ (pentakis(dimethylamido)tantalum, PDMAT), Ta(NEtMe)₅ (pentakis(ethylmethylamido)tantalum, PEMAT), (tBuN)Ta(NMe₂)₃ (tert-butylimino tris(dimethylamido)tantalum, TBTDMT), (tBuN)Ta(NEt₂)₃ (tert-butylimino tris(diethylamido)tantalum, TBTDET), (tBuN)Ta(NEtMe)₃ (tert-butylimino tris(ethylmethylamido)tantalum, TBTEMT), (iAmN)Ta(N Me₂)₃ (iso-amylimino tris(dimethylamido)tantalum, TAIMATA), (iPrN)Ta(NEt₂)₃ (iso-propylimino tris(diethylamido)tantalum, IPTDET), Ta₂(OEt)₁₀ (tantalum penta-ethoxide, TAETO), (Me₂NCH₂CH₂O)Ta(OEt)₄ (dimethylaminoethoxy tantalum tetra-ethoxide, TATDMAE), TaCl₅ (tantalum penta-chloride), Nb(NMe₂)₅ (pentakis(dimethylamido)niobium, PDMANb), Nb₂(OEt)₁₀ (niobium penta-ethoxide, NbETO), (tBuN)Nb(NEt₂)₃ (tert-butylimino tris(diethylamido)niobium, TBTDEN), NbCl₅ (niobium penta-chloride) or the like.

In yet another example, when depositing a film containing a Group VIB element, the Group VIB precursor can include: Cr(CO)₆ (chromium hexacarbonyl), Mo(CO)₆ (molybdenum hexacarbonyl), W(CO)₆ (tungsten hexacarbonyl), WF₆ (tungsten hexafluoride), (tBuN)₂W(NMe₂) (bis(tert-butylimido)bis(dimethylamido)tungsten, BTBMW) or the like.

In yet another example, when depositing a film containing a rare earth metal, the rare earth precursor can have the formula:

ML¹L²L³Dₓ

where M is a rare earth metal element selected from the group of scandium (Sc), yttrium (Y), lutetium (Lu), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), and ytterbium (Yb). L¹, L², L³ are individual anionic ligands, and D is a neutral donor ligand where x can be 0,1, 2, or 3. Each L¹, L², L³ ligand may be individually selected from the groups of alkoxides, halides, aryloxides, amides, cyclopentadienyls, alkyls, silyls, amidinates, β-diketonates, ketoiminates, silanoates, and carboxylates. D ligands may be selected from groups of ethers, furans, pyridines, pyroles, pyrolidines, amines, crown ethers, glymes, and nitriles.

Examples of L groups and D ligands include those presented above for the alkaline earth precursor formula.

Representative examples of rare earth precursors include:

Y precursors: Y(N(SiMe₃)₂)₃, Y(N(iPr)₂)₃, Y(N(tBu)SiMe₃)₃, Y(TMPD)₃, Cp₃Y, (MeCp)₃Y, ((nPr)Cp)₃Y, ((nBu)Cp)₃Y, Y(OCMe₂CH₂NMe₂)₃, Y(THD)₃, Y[OOCCH (C₂H₅)C₄H₉]₃, Y(C₁₁H₁₉O₂)₃CH₃(OCH₂CH₂)₃, Y(CF₃COCHCOCF₃)₃, Y(OOCC₁₀H₇)₃, Y(OOC₁₀H₁₉)₃, Y(O(iPr))₃, or the like.

La precursors: La(N(SiMe₃)₂)₃, La(N(iPr)₂)₃, La(N(tBu)SiMe₃)₃, La(TMPD)₃, ((iPr)Cp)₃La, Cp₃La, Cp₃La(NCCH₃)₂, La(Me₂NC₂H₄Cp)₃, La(THD)₃, La[OOCCH(C₂H₅)C₄H₉]₃, La(C₁₁H₁₉O₂)₃.CH₃(OCH₂CH₂)₃OCH₃, La(C₁₁H₁₉O₂)₃.CH₃(OCH₂CH₂)₄OCH₃, La(O(iPr))₃, La(OEt)₃, La(acac)₃, La(((tBu)₂N)₂CMe)₃, La(((iPr)₂N)₂CMe)₃, La(((tBu)₂N)₂C(tBu))₃, La(((iPr)₂N)₂C(tBu))₃, La(FOD)₃, or the like.

Ce precursors: Ce(N(SiMe₃)₂)₃, Ce(N(iPr)₂)₃, Ce(N(tBu)SiMe₃)₃, Ce(TMPD)₃, Ce(FOD)₃, ((iPr)Cp)₃Ce, Cp₃Ce, Ce(Me₄Cp)₃, Ce(OCMe₂CH₂NMe₂)₃, Ce(THD)₃, Ce[OOCCH(C₂H₅)C₄H₉]₃, Ce(C₁₁H₁₉O₂)₃.CH₃(OCH₂CH₂)₃OCH₃, Ce(C₁₁H₁₉O₂)₃.CH₃(OCH₂CH₂)₄OCH₃, Ce(O(iPr))₃, Ce(acac)₃, or the like.

Pr precursors: Pr(N(SiMe₃)₂)₃, ((iPr)Cp)₃Pr, Cp₃Pr, Pr(THD)₃, Pr(FOD)₃, (C₅Me₄H)₃Pr, Pr[OOCCH(C₂H₅)C₄H₉]₃, Pr(C₁₁H₁₉O₂)₃.CH₃(OCH₂CH₂)₃OCH₃, Pr(O(iPr))₃, Pr(acac)₃, Pr(hfac)₃, Pr(((tBu)₂N)₂CMe)₃, Pr(((iPr)₂N)₂CMe)₃, Pr(((tBu)₂N)₂C(tBu))₃, Pr(((iPr)₂N)₂C(tBu))₃, or the like.

Nd precursors: Nd(N(SiMe₃)₂)₃, Nd(N(iPr)₂)₃, ((iPr)Cp)₃Nd, Cp₃Nd, (C₅Me₄H)₃Nd, Nd(THD)₃, Nd[OOCCH(C₂H₅)C₄H₉]₃, Nd(O(iPr))₃, Nd(acac)₃, Nd(hfac)₃, Nd(F₃CC(O)CHC(O)CH₃)₃, Nd(FOD)₃, or the like.

Sm precursors: Sm(N(SiMe₃)₂)₃, ((iPr)Cp)₃Sm, Cp₃Sm, Sm(THD)₃, Sm[OOCCH(C₂H₅)C₄H₉]₃, Sm(O(iPr))₃, Sm(acac)₃, (C₅Me₅)₂Sm, or the like.

Eu precursors: Eu(N(SiMe₃)₂)₃, ((iPr)Cp)₃Eu, Cp₃Eu, (Me₄Cp)₃Eu, Eu(THD)₃, Eu[OOCCH(C₂H₅)C₄H₉]₃, Eu(O(iPr))₃, Eu(acac)₃, (C₅Me₅)₂Eu, or the like.

Gd precursors: Gd(N(SiMe₃)₂)₃, ((iPr)Cp)₃Gd, Cp₃Gd, Gd(THD)₃, Gd[OOCCH(C₂H₅)C₄H₉]₃, Gd(O(iPr))₃, Gd(acac)₃, or the like.

Tb precursors: Tb(N(SiMe₃)₂)₃, ((iPr)Cp)₃Tb, Cp₃Tb, Tb(THD)₃, Tb[OOCCH(C₂H₅)C₄H₉]₃, Tb(O(iPr))₃, Tb(acac)₃, or the like.

Dy precursors: Dy(N(SiMe₃)₂)₃, ((iPr)Cp)₃Dy, Cp₃Dy, Dy(THD)₃, Dy[OOCCH(C₂H₅)C₄H₉]₃, Dy(O(iPr))₃, Dy(O₂C(CH₂)₆CH₃)₃, Dy(acac)₃, or the like.

Ho precursors: Ho(N(SiMe₃)₂)₃, ((iPr)Cp)₃Ho, Cp₃Ho, Ho(THD)₃, Ho[OOCCH(C₂H₅)C₄H₉]₃, Ho(O(iPr))₃, Ho(acac)₃, or the like.

Er precursors: Er(N(SiMe₃)₂)₃, ((iPr)Cp)₃Er, ((nBu)Cp)₃Er, Cp₃Er, Er(THD)₃, Er[OOCCH(C₂H₅)C₄H₉]₃, Er(O(iPr))₃, Er(acac)₃, or the like.

Tm precursors: Tm(N(SiMe₃)₂)₃, ((iPr)Cp)₃Tm, Cp₃Tm, Tm(THD)₃, Tm[OOCCH(C₂H₅)C₄H₉]₃, Tm(O(iPr))₃, Tm(acac)₃, or the like.

Yb precursors: Yb(N(SiMe₃)₂)₃, Yb(N(iPr)₂)₃, ((iPr)Cp)₃Yb, Cp₃Yb, Yb(THD)₃, Yb[OOCCH(C₂H₅)C₄H₉]₃, Yb(O(iPr))₃, Yb(acac)₃, (C₅Me₅)₂Yb, Yb(hfac)₃, Yb(FOD)₃, or the like.

Lu precursors: Lu(N(SiMe₃)₂)₃, ((iPr)Cp)₃Lu, Cp₃Lu, Lu(THD)₃, Lu[OOCCH(C₂H₅)C₄H₉]₃, Lu(O(iPr))₃, Lu(acac)₃, or the like.

In the above precursors, as well as precursors set forth below, the following common abbreviations are used: Si: silicon; Me: methyl; Et: ethyl; iPr: isopropyl; nPr: n-propyl; Bu: butyl; nBu: n-butyl; sBu: sec-butyl; iBu: iso-butyl; tBu: tert-butyl; iAm: iso-amyl; Cp: cyclopentadienyl; THD: 2,2,6,6-tetramethyl-3,5-heptanedionate; TMPD: 2,2,6,6-tetramethylpiperidide; acac: acetylacetonate; hfac: hexafluoroacetylacetonate; and FOD: 6,6,7,7,8,8,8-heptafluoro-2,2-dimethyl-3,5-octanedionate.

In yet another example, the film precursor may include a wide variety of Group III precursors for incorporating aluminum into the nitride films. For example, many aluminum precursors have the formula:

AIL¹L²L³Dₓ

where L¹, L², L³ are individual anionic ligands, and D is a neutral donor ligand where x can be 0, 1, or 2. Each L¹, L², L³ ligand may be individually selected from the groups of alkoxides, halides, aryloxides, amides, cyclopentadienyls, alkyls, silyls, amidinates, β-diketonates, ketoiminates, silanoates, and carboxylates. D ligands may be selected from groups of ethers, furans, pyridines, pyroles, pyrolidines, amines, crown ethers, glymes, and nitriles.

Other examples of Group III precursors include: Al₂Me₆, Al₂Et₆, [Al(O(sBu))₃]₄, Al(CH₃COCHCOCH₃)₃, AlBr₃, All₃, Al(O(iPr))₃, [Al(NMe₂)₃]₂, Al(iBu)₂Cl, Al(iBu)₃, Al(iBu)₂H, AlEt₂Cl, Et₃Al₂(O(sBu))₃, Al(THD)₃, GaCl₃, InCl₃, GaH₃ InH₃, or the like.

In order to achieve the desired temperature for vaporizing the film precursor, the precursor evaporation system 190 is coupled to a vaporization temperature control system (not shown) configured to control the vaporization temperature. For instance, the temperature of the film precursor is generally elevated to approximately 40° C. and above in order to sublime ruthenium carbonyl Ru₃(CO)₁₂. At this temperature, the vapor pressure of the Ru₃(CO)₁₂, for instance, ranges from approximately 1 to approximately 3 mTorr.

As the film precursor is heated to cause evaporation (or sublimation), a carrier gas can be passed over, passed over in close proximity to, or through the film precursor, or any combination thereof. The carrier gas can include, for example, an inert gas, such as a noble gas, He, Ne, Ar, Kr, or Xe, or a combination of two or more thereof. Alternately, other embodiments contemplate omitting the inert carrier gas. Additionally, a monoxide gas, such as carbon monoxide (CO), can be added to the inert carrier gas. Alternately, other arrangements contemplate the monoxide gas replacing the inert carrier gas. Of course, other carrier gasses can be employed.

As described above, in order to produce high quality thin films having repeatable properties, it is essential to provide the ability to precisely determine and control the amount of film precursor that is delivered to the substrate and the partial pressure (or concentration) of film precursor transported within the carrier gas. Therefore, according to one embodiment, a method and system is provided for determining and controlling the amount of film precursor delivered to the substrate, while determining and controlling the partial pressure or concentration of film precursor vapor within the carrier gas flow. For example, a method is described for controlling the amount, flow rate, partial pressure, concentration, or any combination thereof (collectively referred to throughout this patent as “amount”) of film precursor delivered to the substrate, while maintaining a predetermined value of, e.g., substantially constant, concentration of film precursor within the carrier gas flow.

Referring still to FIG. 1, the vapor delivery system 140 further comprises a carrier gas supply system 152 that is configured to supply the carrier gas, such as an inert gas, or a monoxide gas, or a mixture thereof, to the film precursor within the precursor evaporation system 190. Therein, the carrier gas supply system 152 is coupled to the precursor evaporation system 190, and it is configured to supply the carrier gas that entrains film precursor vapor and assists the transport of the film precursor vapor through a vapor delivery line 192 to the substrate 125 in process chamber 110. Additionally, the carrier gas supply system 152 is further coupled to the process chamber 110 via a separate by-pass gas line 170 that by-passes the precursor evaporation system 190.

The carrier gas supply system 152 is configured to introduce a first flow of carrier gas to the process chamber 110 that passes through the precursor evaporation system 190, receives the film precursor vapor, and flows through the vapor delivery line 192 to the process chamber 110. Additionally, the carrier gas supply system 152 is configured to introduce a second flow of carrier gas to the process chamber 110 through the by-pass gas line 170 that by-passes the precursor evaporation system 190.

Referring still to FIG. 1, the vapor delivery system 140 further comprises a carrier gas flow control system 150 coupled to an output of the carrier gas supply system 152, and configured to control the amount, e.g., flow rate, of the first flow of carrier gas and control the amount, e.g., flow rate, of the second flow of carrier gas. Additionally, the vapor delivery system 140 further comprises a film precursor vapor flow measurement system 160 coupled to an inlet of the precursor evaporation system 190 and an outlet of the precursor evaporation system 190, and configured to measure an amount of the film precursor vapor introduced to the first flow of carrier gas.

Additionally yet, as shown in FIG. 1, the vapor delivery system 140 comprises a controller 145 coupled to the carrier gas flow control system 150 and the film precursor vapor flow measurement system 160, wherein the controller 145 is configured to compare the measured amount of the film precursor vapor to a target amount of the film precursor vapor. The controller 145 is configured to adjust the amount, e.g., flow rate, of the first flow of carrier gas such that the measured amount of the film precursor vapor is substantially equal to the target amount of the film precursor vapor. For example, an increase in the flow rate can lead to an increase in the amount of film precursor vapor, and a decrease in the flow rate can lead to a decrease on the amount of film precursor vapor.

Furthermore, the controller 145 is configured to adjust the amount, e.g., flow rate, of the second flow of the carrier gas such that the total amount of the first flow of the carrier gas and the second flow of the carrier gas is a predetermined value, e.g., substantially constant. Thus, the sum of the flow rate of the first flow of carrier gas and the flow rate of the second flow of carrier gas can be maintained substantially constant. For example, an increase in the flow rate of the first flow of carrier gas in order to increase the amount of film precursor vapor is compensated by a decrease in the flow rate of the second flow of carrier gas. Additionally, for example, a decrease in the flow rate of the first flow of carrier gas in order to decrease the amount of film precursor vapor is compensated by an increase in the flow rate of the second flow of carrier gas.

Although the method for controlling the amount of film precursor vapor delivered to the substrate is described in the context of maintaining a substantially constant amount, e.g., partial pressure or concentration, of film precursor vapor within the combined flow of carrier gas flows, other embodiments are contemplated. For example, the amount of film precursor vapor delivered to the substrate may be controllably varied during the deposition process. The variation in the target amount of film precursor vapor may include step variations, or ramped variations, or variations according to a prescribed mathematical function in time.

The variation in the amount of film precursor vapor may be controllably performed while maintaining a substantially constant total amount, e.g., flow rate, of the combined flows of carrier gas (first and second flows of carrier gas), or while maintaining a substantially constant partial pressure or concentration of film precursor vapor in the combined flows of carrier gas, or while controllably performing variations in the amount, e.g., partial pressure or concentration, of precursor vapor in the combined flows of carrier gas, or while performing any combination thereof.

Alternatively, for example, the amount, e.g., concentration or partial pressure, of film precursor vapor within the combined flows of carrier gas delivered to the substrate may be controllably varied during the deposition process. The variation in amount, e.g., partial pressure or concentration, may include step variations, or ramped variations, or variations according to a prescribed mathematical function in time of the target amount of film precursor, or target amount, e.g., flow rate, of carrier gas, or a combination thereof.

As shown in FIG. 1, the carrier gas flow control system 150 comprises a first mass flow controller 156 configured to control the flow rate of the first flow of carrier gas, and a second mass flow controller 154 configured to control the flow rate of the second flow of carrier gas. Additionally, as shown in FIG. 1, the film precursor vapor flow measurement system 160 comprises a first flow measurement device 162 coupled to an inlet of the precursor evaporation system 190, and a second flow measurement device 164 coupled to an outlet of the precursor evaporation system 190. The first flow measurement device 162 and the second mass flow measurement device 164 may, for example, include a Coriolis-type mass flow meter, such as a Quantim® Coriolis Precision Mass Flow meter commercially available from Emerson Process Management, Brooks Instrument (407 West Vine Street, Hatfield, Pa. 19440-0903).

During operation, the controller 145 acquires a first signal from the first flow measurement device 162 and a second signal from the second flow measurement device 164, whereby a difference between the first and second signals is related to the amount of film precursor vapor introduced to the first flow of carrier gas. Assuming the time rate of change of the gas density in the precursor evaporation system 190 is substantially nil (e.g. steady-state behavior), conservation of mass requires that the difference between the mass flow rate of material exiting the precursor evaporation system 190 and the mass flow rate of material entering the precursor evaporation system 190 must equate to the amount of film precursor vapor that evolves within the precursor evaporation system 190.

Although not shown, the carrier gas supply system 152 can comprise a carrier gas source, one or more control valves, one or more filters, and additional mass flow controllers. For instance, the flow rate of the carrier gas can be between about 0.1 standard cubic centimeters per minute (sccm) and about 10,000 sccm. Alternately, the flow rate of the carrier gas can be between about 10 sccm and about 500 sccm. Still alternately, the flow rate of the carrier gas can be between about 50 sccm and about 200 sccm.

Downstream from the precursor evaporation system 190, the film precursor vapor flows with the carrier gas through the vapor delivery line 192 until it enters the process chamber 110. The vapor delivery system 140, including the precursor evaporation system 190 and the vapor delivery line 192, can be coupled to a temperature control system (not shown), as described above. As illustrated in FIG. 1, the first mass flow measurement device 162, the second mass flow measurement device 164, the precursor evaporation system 190, and the vapor delivery line 192 may be maintained at an elevated temperature.

For example, the precursor evaporation system 190 is operated at an elevated temperature (i.e., an evaporation temperature) suitable for evaporating or subliming the film precursor. Additionally, for example, the vapor delivery line is operated at an elevated temperature in order to control the vapor line temperature and prevent decomposition of the film precursor vapor as well as condensation of the film precursor vapor. For example, the vapor line temperature can be set to a value approximately equal to or greater than the vaporization temperature. Additionally, for example, the vapor delivery line 192 can be characterized by a high conductance gas duct having a flow conductance in excess of about 50 liters/second.

Referring still to FIG. 1, the vapor deposition system 100 may comprise a vapor distribution system (not shown), which is coupled to the process chamber 110 and configured to receive the flow of film precursor vapor and carrier gas and distribute the flow within process space 115 above substrate 125. For example, the vapor distribution system may comprise a plenum within which the vapor disperses prior to passing through a vapor distribution plate and entering process space 115 above substrate 125. In addition, the vapor distribution plate can be coupled to a distribution plate temperature control system (not shown) configured to control the temperature of the vapor distribution plate. For example, the temperature of the vapor distribution plate can be set to a value approximately equal to the vapor delivery line temperature. However, it may be less, or it may be greater.

As illustrated in FIG. 1, the by-pass gas line 170, through which the second flow of carrier gas passes, may couple to the vapor delivery line 192 downstream of the precursor evaporation system 190 and the second mass flow measurement device 164, wherein the second flow of carrier gas may mix with the first flow of carrier gas and film precursor vapor and equilibrate with the vapor line temperature. Alternatively, the by-pass gas line 170 may couple to the vapor deposition system 100. For example, the by-pass gas line 170 may couple to the vapor distribution system, or the by-pass gas line 170 may couple downstream of the vapor distribution system at the process space 115 above substrate 125.

Furthermore, the vapor deposition system 100 may optionally include a dilution gas source coupled to the process chamber 110 and/or vapor distribution system that is configured to add a dilution gas to dilute the process gas containing the film precursor vapor and the carrier gas. The dilution gas source can be coupled to the vapor distribution system and configured to add the dilution gas to the process gas in the vapor distribution plenum before the process gas passes through the vapor distribution plate into process space 115. Alternately, the dilution gas source can be coupled to the process chamber 110 and configured to add the dilution gas to the process gas in process space 115 above the substrate 125 after the process gas passes through the vapor distribution plate. Still alternately, the dilution gas source can be coupled to the vapor distribution system and configured to add the dilution gas to the process gas in the distribution plate. As will be appreciated by those skilled in the art, the dilution gas can be added to the process gas at other locations in the vapor distribution system and the process chamber 110.

Once film precursor vapor enters process space 115, the film precursor vapor thermally decomposes upon adsorption at the substrate surface due to the elevated temperature of the substrate 125, and the thin film is formed on the substrate 125. The substrate holder 120 is configured to elevate the temperature of substrate 125 by virtue of the substrate holder 120 being coupled to a substrate temperature control system (not shown). For example, the substrate temperature control system can be configured to elevate the temperature of substrate 125 up to approximately 500° C. The substrate temperature can range from about 100° C. to about 500° C. Alternately, the substrate temperature can range from about 150° C. to about 350° C. Additionally, process chamber 110 can be coupled to a chamber temperature control system (not shown) configured to control the temperature of the chamber walls.

In addition to being coupled to the carrier gas flow control system 150 and the film precursor vapor flow measurement system 160, controller 145 may be coupled to the precursor evaporation system 190, the carrier gas supply system 152, the process chamber 110, the substrate holder 120, and the vacuum pumping system 120. The controller 145 can include a microprocessor, a memory, and a digital I/O port capable of generating control voltages sufficient to communicate and activate inputs of the deposition system 100 as well as monitor outputs from the deposition system 100. Moreover, the controller 145 can be coupled to and exchange information with any one or more of the components described above. A program stored in the memory can be utilized to control the aforementioned components of deposition system 100 according to a stored process recipe. One example of processing system controller 145 is a DELL PRECISION WORKSTATION 610™, available from Dell Corporation, Dallas, Tex. The controller 145 may also be implemented as a general-purpose computer, digital signal process or, etc.

Controller 145 may be locally located relative to the deposition system 100, or it may be remotely located relative to the deposition system 100 via the internet or an intranet. Thus, controller 145 can exchange data with the deposition system 100 using at least one of a direct connection, an intranet, or the internet. Controller 145 may be coupled to an intranet at a customer site (i.e., a device maker, etc.), or coupled to an intranet at a vendor site (i.e., an equipment manufacturer). Furthermore, another computer (i.e., controller, server, etc.) can access controller 145 to exchange data via at least one of a direct connection, an intranet, or the internet.

In yet another embodiment, the ratio of the flow rate of the second flow of carrier gas and the first flow of carrier gas may be utilized to provide an indication of the usable lifetime of the precursor evaporation system 190. As the film precursor in the precursor evaporation system 190 becomes depleted, the flow rate of the first flow of carrier gas will continue to rise (in an attempt to entrain additional film precursor vapor to meet the prescribed amount of film precursor to be delivered to the substrate) as the flow rate of the second flow of carrier gas will continue to descend (in order to maintain a constant total mass flow rate). Hence, the ratio of the second carrier gas flow rate to the first carrier gas flow rate will approach zero as the film precursor stored in the precursor evaporation system 190 diminishes. At some pre-determined value of this ratio, the precursor evaporation system 190 may be replaced.

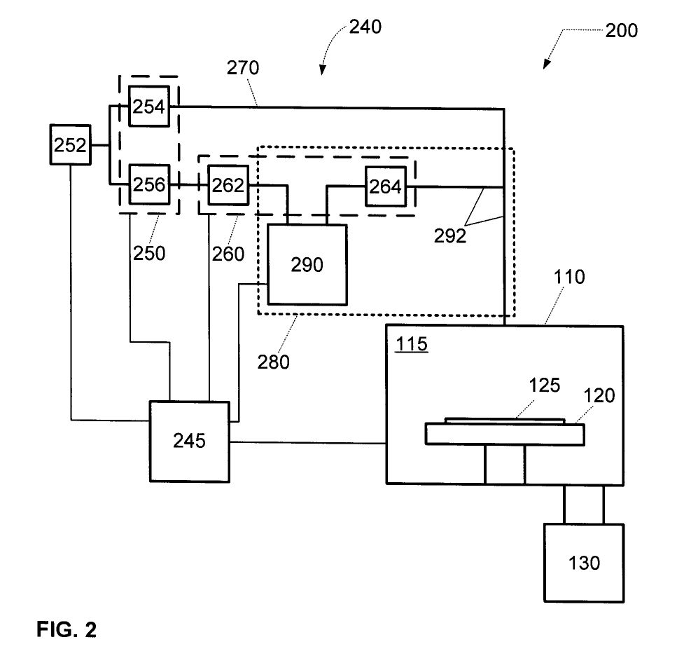

Referring now to FIG. 2, a vapor deposition system 200 is described according to another embodiment, wherein like reference numerals designate identical or corresponding parts. The vapor deposition system 200 comprises a vapor delivery system 240 having a carrier gas supply system 252 that is configured to supply the carrier gas, such as an inert gas, or a monoxide gas, or a mixture thereof, to the film precursor within the precursor evaporation system 290. Therein, the carrier gas supply system 252 is coupled to the precursor evaporation system 290, and it is configured to supply the carrier gas that entrains film precursor vapor and assists the transport of the film precursor vapor through a vapor delivery line 292 to the substrate 125 in process chamber 110. Additionally, the carrier gas supply system 252 is further coupled to the process chamber 110 via a separate by-pass gas line 270 that by-passes the precursor evaporation system 290.

The carrier gas supply system 252 is configured to introduce a first flow of carrier gas to the process chamber 110 that passes through the precursor evaporation system 290, receives the film precursor vapor, and flows through the vapor delivery line 292 to the process chamber 110. Additionally, the carrier gas supply system 252 is configured to introduce a second flow of carrier gas to the process chamber 110 through the by-pass gas line 270 that by-passes the precursor evaporation system 290.

Referring still to FIG. 2, the vapor delivery system 240 further comprises a carrier gas flow control system 250 coupled to an output of the carrier gas supply system 252, and configured to control the amount, e.g., flow rate, of the first flow of carrier gas and control the amount, e.g., flow rate, of the second flow of carrier gas. Additionally, the vapor delivery system 240 further comprises a film precursor vapor flow measurement system 260 coupled to an inlet of the precursor evaporation system 290 and an outlet of the precursor evaporation system 290, and configured to measure an amount of the film precursor vapor introduced to the first flow of carrier gas.

Additionally yet, as shown in FIG. 2, the vapor delivery system 240 comprises a controller 245 coupled to the carrier gas flow control system 250 and the film precursor vapor flow measurement system 260, wherein the controller 245 is configured to compare the measured amount of the film precursor vapor to a target amount of the film precursor vapor. The controller 245 is configured to adjust the amount, e.g., flow rate, of the first flow of carrier gas such that the measured amount of the film precursor vapor is substantially equal to the target amount of the film precursor vapor. For example, an increase in the flow rate can lead to an increase in the amount of film precursor vapor, and a decrease in the flow rate can lead to a decrease on the amount of film precursor vapor.

Furthermore, the controller 245 is configured to adjust the amount, e.g., flow rate, of the second flow of the carrier gas such that the total amount, e.g., flow rate, of the first flow of the carrier gas and the second flow of the carrier gas is a predetermined value, e.g., substantially constant. Thus, the sum of the flow rate of the first flow of carrier gas and the flow rate of the second flow of carrier gas can be maintained substantially constant. For example, an increase in the flow rate of the first flow of carrier gas in order to increase the amount of film precursor vapor is compensated by a decrease in the flow rate of the second flow of carrier gas. Additionally, for example, a decrease in the flow rate of the first flow of carrier gas in order to decrease the amount of film precursor vapor is compensated by an increase in the flow rate of the second flow of carrier gas.

As shown in FIG. 2, the carrier gas flow control system 250 comprises a first mass flow controller 256 configured to control the flow rate of the first flow of carrier gas, and a second mass flow controller 254 configured to control the flow rate of the second flow of carrier gas. Additionally, as shown in FIG. 2, the film precursor vapor flow measurement system 260 comprises a first flow measurement device 262 coupled to an inlet of the precursor evaporation system 290, and a second flow measurement device 264 coupled to an outlet of the precursor evaporation system 290. The first flow measurement device 262 and the second mass flow measurement device 264 may, for example, include a Coriolis-type mass flow meter, such as a Quantim® Coriolis Precision Mass Flow meter commercially available from Emerson Process Management.

During operation, the controller 245 acquires a first signal from the first flow measurement device 262 and a second signal from the second flow measurement device 264, whereby a difference between the first and second signals is related to the amount of film precursor vapor introduced to the first flow of carrier gas. Assuming the time rate of change of the gas density in the precursor evaporation system 290 is substantially nil, conservation of mass requires that the difference between the mass flow rate of material exiting the precursor evaporation system 290 and the mass flow rate of material entering the precursor evaporation system 290 must equate to the amount of film precursor vapor that evolves within the precursor evaporation system 290.

Downstream from the precursor evaporation system 290, the film precursor vapor flows with the carrier gas through the vapor delivery line 292 until it enters the process chamber 110. The vapor delivery system 240, including the precursor evaporation system 290 and the vapor delivery line 292, can be coupled to a temperature control system (not shown), as described above. As illustrated in FIG. 2, the second mass flow measurement device 264, the precursor evaporation system 290, and the vapor delivery line 292 may be maintained at an elevated temperature, while the first mass flow measurement device 262 is not maintained at the elevated temperature.

Furthermore, the first mass flow measurement device 262 may be utilized to calibrate the first mass flow controller 256. Thereafter, the first mass flow measurement device 262 may be removed, and the amount of film precursor vapor introduced to the first flow of carrier gas can be related to the difference between signals received from the second mass flow measurement device 264 and the first mass flow controller 256. In this case, the first mass flow controller can produce a signal related to the mass flow therethrough.

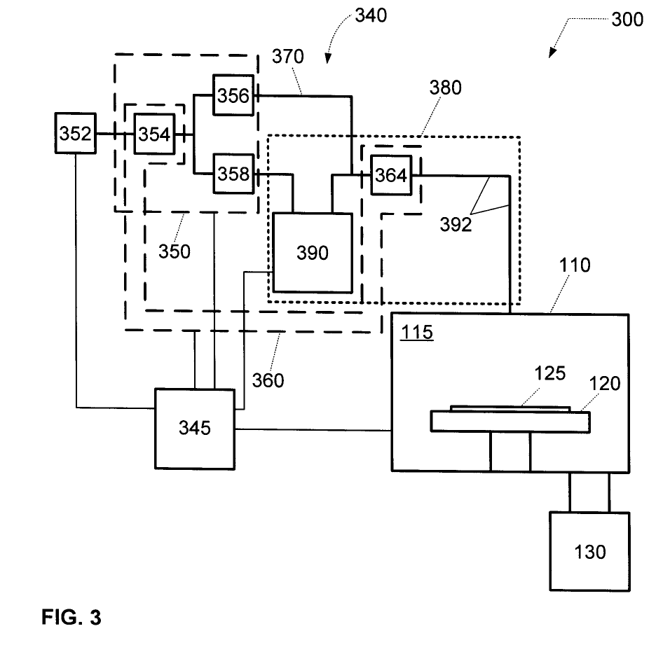

Referring now to FIG. 3, a vapor deposition system 300 is described according to another embodiment, wherein like reference numerals designate identical or corresponding parts. The vapor deposition system 300 comprises a vapor delivery system 340 having a carrier gas supply system 352 that is configured to supply the carrier gas, such as an inert gas, or a monoxide gas, or a mixture thereof, to the film precursor within the precursor evaporation system 390. Therein, the carrier gas supply system 352 is coupled to the precursor evaporation system 390, and it is configured to supply the carrier gas that entrains film precursor vapor and assists the transport of the film precursor vapor through a vapor delivery line 392 to the substrate 125 in process chamber 110. Additionally, the carrier gas supply system 352 is further coupled to the process chamber 110 via a separate by-pass gas line 370 that by-passes the precursor evaporation system 390.

The carrier gas supply system 352 is configured to introduce a first flow of carrier gas to the process chamber 110 that passes through the precursor evaporation system 390, receives the film precursor vapor, and flows through the vapor delivery line 392 to the process chamber 110. Additionally, the carrier gas supply system 352 is configured to introduce a second flow of carrier gas to the process chamber 110 through the by-pass gas line 370 that by-passes the precursor evaporation system 390.

Referring still to FIG. 3, the vapor delivery system 340 further comprises a carrier gas flow control system 350 coupled to an output of the carrier gas supply system 352, and configured to control the amount, e.g., flow rate, of the first flow of carrier gas and control the amount, e.g., flow rate, of the second flow of carrier gas. Additionally, the vapor delivery system 340 further comprises a film precursor vapor flow measurement system 360 coupled to an inlet of the precursor evaporation system 390 and an outlet of the precursor evaporation system 390, and configured to measure an amount of the film precursor vapor introduced to the combined flow of carrier gas.

Additionally yet, as shown in FIG. 3, the vapor delivery system 340 comprises a controller 345 coupled to the carrier gas flow control system 350 and the film precursor vapor flow measurement system 360, wherein the controller 345 is configured to compare the measured amount of the film precursor vapor to a target amount of the film precursor vapor. The controller 345 is configured to adjust the amount, e.g., flow rate, of the first flow of carrier gas such that the measured amount of the film precursor vapor is substantially equal to the target amount of the film precursor vapor. For example, an increase in the flow rate can lead to an increase in the amount of film precursor vapor, and a decrease in the flow rate can lead to a decrease on the amount of film precursor vapor.

Furthermore, the controller 345 is configured to adjust the amount, e.g., flow rate, of the second flow of the carrier gas such that the total amount, e.g., flow rate of the first flow of the carrier gas and the second flow of the carrier gas is a predetermined value, e.g., substantially constant Thus, the sum of the flow rate of the first flow of carrier gas and the flow rate of the second flow of carrier gas can be maintained substantially constant. For example, an increase in the flow rate of the first flow of carrier gas in order to increase the amount of film precursor vapor is compensated by a decrease in the flow rate of the second flow of carrier gas. Additionally, for example, a decrease in the flow rate of the first flow of carrier gas in order to decrease the amount of film precursor vapor is compensated by an increase in the flow rate of the second flow of carrier gas.

As shown in FIG. 3, the carrier gas flow control system 350 comprises a mass flow controller 354 configured to control the total amount, e.g., flow rate of carrier gas (i.e., the sum of the amount, e.g., flow rate, of the first flow of carrier gas and the amount, e.g., flow rate, of the second flow of carrier gas). Additionally, as shown in FIG. 3, the carrier gas flow control system 350 further comprises a first valve 358 having an inlet coupled to an output of the mass flow controller 354 and an outlet coupled to the precursor evaporation system 390, and a second valve 356 having an inlet coupled to the output of the mass flow controller 354 and an outlet coupled to the by-pass gas line 370. The first valve 358 and the second valve 356 may include needle valves. The first valve 358 and the second valve 356 are controllably operated in order to affect the fraction of the total flow rate of carrier gas that passes through the precursor evaporation system 390 as the first flow of carrier gas and the remaining fraction of the total flow rate of carrier gas that passes through the by-pass gas line 370. Optionally, only one of the first valve 358 and the second valve 356 are utilized.

Additionally yet, as shown in FIG. 3, the film precursor vapor flow measurement system 360 comprises a flow measurement device 364 coupled to an outlet of the precursor evaporation system 390. The flow measurement device 364 may, for example, include a Coriolis-type mass flow meter, such as a Quantim® Coriolis Precision Mass Flow meter commercially available from Emerson Process Management.

As illustrated in FIG. 3, the by-pass gas line 370, through which the second flow of carrier gas passes, couples to the vapor delivery line 392 downstream of the precursor evaporation system 190 and upstream of the mass flow measurement device 364. Hence, the mass flow measurement performed by the mass flow measurement device 364 is indicative of the total mass flow rate, including the total flow rate of carrier gas and the total flow rate of film precursor vapor. During operation, the controller 345 acquires a first signal from the mass flow controller 354 and a second signal from the mass flow measurement device 364, whereby a difference between the first and second signals is related to the amount of film precursor vapor introduced to the first flow of carrier gas.

Downstream from the precursor evaporation system 390 and the mass flow measurement device 364, the film precursor vapor flows with the combined flow of carrier gas through the remainder of the vapor delivery line 392 until it enters the process chamber 110. The vapor delivery system 340, including the precursor evaporation system 390 and the vapor delivery line 392, can be coupled to a temperature control system (not shown), as described above. As illustrated in FIG. 3, the mass flow measurement device 364, the precursor evaporation system 390, and the vapor delivery line 392 may be maintained at an elevated temperature.

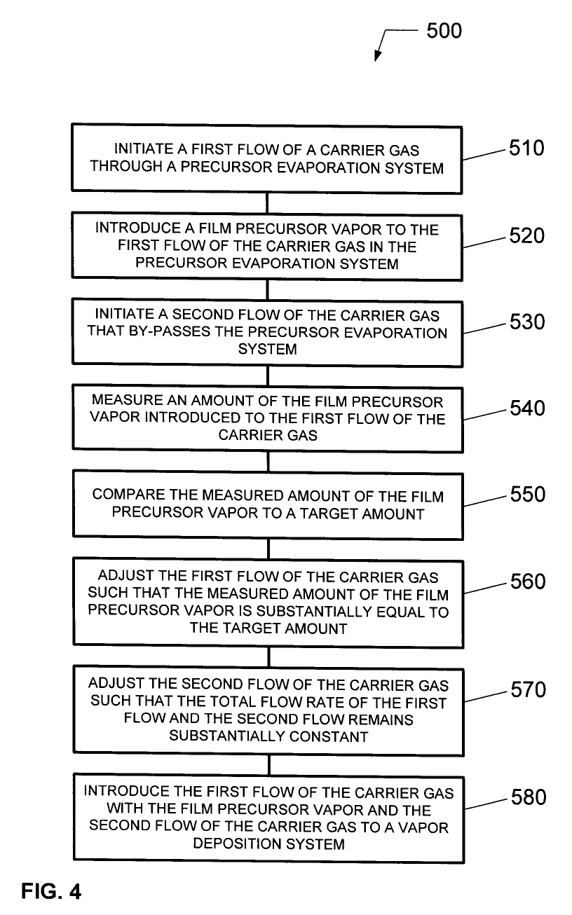

Referring now to FIG. 4, a method of controlling the amount, e.g., flow rate, of film precursor vapor to a substrate in a vapor deposition system is provided according to an embodiment. The vapor deposition system may include any deposition system configured to deposit a film from a vapor-phase film precursor, including any of the vapor deposition systems described above. The method is represented as a flow chart 500 beginning in 510 with initiating a first flow of a carrier gas through a precursor evaporation system.

In 520, the film precursor vapor is introduced to the first flow of the carrier gas in the precursor evaporation system.

In 530, a second flow of the carrier gas is initiated that by-passes the precursor evaporation system.

Thereafter, in 540, the amount of film precursor vapor introduced to the first flow of the carrier gas is measured and, in 550, the measured amount, e.g., flow rate of film precursor vapor is compared with a target amount of film precursor vapor.

In 560, the amount, e.g., flow rate, of the first flow of the carrier gas is adjusted in order to adjust the measured amount of film precursor vapor such that it is substantially equivalent to the target amount.

In 570, the amount, e.g., flow rate, of the second flow of the carrier gas is adjusted such that a total amount, e.g., flow rate, of the first flow of the carrier gas and the second flow of the carrier gas achieves a predetermined value, e.g., remains substantially constant.

In 580, the first flow of the carrier gas with the film precursor vapor, and the second flow of the carrier gas are introduced to the vapor deposition system.

Additionally, one or more flow conditions comprising the amount, e.g., flow rate, of the first flow of the carrier gas, the amount, e.g., flow rate, of the second flow of the carrier gas, a ratio between the amount, e.g., flow rate, of the first flow of the carrier gas and the total amount, e.g., flow rate, of the first flow and the second flow of the carrier gas, a ratio between the amount, e.g., flow rate, of the second flow of the carrier gas and the total amount, e.g., flow rate, of the first flow and the second flow of the carrier gas, or a ratio between the amount, e.g., flow rate, of the second flow of the carrier gas and the amount, e.g., flow rate, of the first flow of the carrier gas, or a combination of two or more flow conditions thereof are monitored in order to determine the usable lifetime of the film precursor within the precursor evaporation system. For example, the film precursor, or the precursor evaporation system, or both may be replaced when the ratio between the flow rate of the second flow of the carrier gas and the flow rate of the first flow of the carrier gas is less than or equal to a pre-determined threshold value.

Although only certain exemplary embodiments of inventions have been described in detail above, those skilled in the art will readily appreciate that many modifications are possible in the exemplary embodiments without materially departing from the novel teachings and advantages of this invention.

1. A method of controlling a film precursor vapor in a vapor deposition system, comprising:
initiating a first flow of a carrier gas through a precursor evaporation system;
introducing said film precursor vapor to said first flow of said carrier gas in said precursor evaporation system;
initiating a second flow of said carrier gas that by-passes said precursor evaporation system;
measuring an amount of said film precursor vapor introduced to said first flow of said carrier gas;
comparing said amount of said film precursor vapor to a target amount of said film precursor vapor;
adjusting said first flow of said carrier gas through said precursor evaporation system such that said measured amount of said film precursor vapor is substantially equal to said target amount of said film precursor vapor;
adjusting said second flow of said carrier gas such that a total amount of said first flow of said carrier gas and said second flow of said carrier gas remains substantially constant; and
introducing said first flow of said carrier gas with said film precursor vapor, and said second flow of said carrier gas to said vapor deposition system.

2. The method of claim 1, further comprising:
determining the usable lifetime of said film precursor within said precursor evaporation system by monitoring one or more flow conditions comprising the flow rate of said first flow of said carrier gas, the flow rate of said second flow of said carrier gas, a ratio between the flow rate of said first flow of said carrier gas and the total flow rate of said first flow and said second flow of said carrier gas, a ratio between the flow rate of said second flow of said carrier gas and the total flow rate of said first flow and said second flow of said carrier gas, or a ratio between the flow rate of said second flow of said carrier gas and the flow rate of said first flow of said carrier gas, or a combination of two or more flow conditions thereof.

3. The method of claim 2, wherein said determining comprises:
monitoring said ratio between the flow rate of said first flow of said carrier gas and the flow rate of said second flow of said carrier gas; and
replacing said film precursor, or said precursor evaporation system, or both when said ratio between the flow rate of said second flow of said carrier gas and the flow rate of said first flow of said carrier gas is less than or equal to a pre-determined threshold value.

4. The method of claim 1, wherein said introducing said film precursor vapor comprises subliming a solid-phase material in said precursor evaporation system.

5. The method of claim 1, wherein said introducing said film precursor vapor comprises evaporating a metal-carbonyl.

6. The method of claim 1, wherein said introducing said film precursor vapor comprises evaporating W(CO)₆, Mo(CO)₆, Co₂(CO)₈, Rh₄(CO)₁₂, Re₂(CO)₁₀, Cr(CO)₆, or Ru₃(CO)₁₂, or any combination thereof.

7. The method of claim 1, wherein said measuring said amount of said film precursor vapor comprises measuring a mass flow rate of said film precursor vapor introduced to said first flow of said carrier gas.

8. The method of claim 1, wherein said initiating said first flow of a carrier gas comprises initiating a flow of an inert gas.

9. The method of claim 8, wherein said initiating said flow of said inert gas comprises initiating a flow of a noble gas.

10. The method of claim 1, wherein said initiating said first flow of a carrier gas comprises initiating a flow of a monoxide gas.

11. The method of claim 10, wherein said initiating said flow of said monoxide gas comprises initiating a flow of carbon monoxide (CO).

12. The method of claim 1, further comprising:
introducing a dilution gas to said substrate in said process chamber.

13. The method of claim 12, wherein said introducing said dilution gas comprises introducing an inert gas.

14. The method of claim 12, wherein said introducing said dilution gas comprises introducing a dilution gas to said first flow of said carrier gas and said film precursor downstream of said precursor evaporation system.

15. A computer readable medium containing program instructions for execution on a vapor deposition system, which when executed by the vapor deposition system, cause the vapor deposition system to perform the steps of:
initiating a first flow of a carrier gas through a precursor evaporation system;
introducing said film precursor vapor to said first flow of said carrier gas in said precursor evaporation system;
initiating a second flow of said carrier gas that by-passes said precursor evaporation system;
measuring an amount of said film precursor vapor introduced to said first flow of said carrier gas;
comparing said amount of said film precursor vapor to a target amount of said film precursor vapor;
adjusting said first flow of said carrier gas through said precursor evaporation system such that said measured amount of said film precursor vapor is substantially equal to said target amount of said film precursor vapor;
adjusting said second flow of said carrier gas such that a total amount of said first flow of said carrier gas and said second flow of said carrier gas achieves a predetermined value; and
introducing said first flow of said carrier gas with said film precursor vapor, and said second flow of said carrier gas to a substrate within said vapor deposition system.

16. A vapor deposition system for forming a thin film on a substrate, comprising:
a process chamber having a substrate holder configured to support said substrate and heat said substrate, a vapor distribution system configured to introduce a film precursor vapor above said substrate, and a pumping system configured to evacuate said process chamber; and
a vapor delivery system coupled to said process chamber, and configured to introduce said film precursor vapor to said substrate in said process chamber, said vapor delivery system comprising:
a precursor evaporation system configured to evaporate a film precursor to form said film precursor vapor;
a carrier gas supply system coupled to said process chamber and said precursor evaporation system, wherein said carrier gas supply system is configured to introduce a first flow of a carrier gas to said process chamber that passes through said precursor evaporation system and receives said film precursor vapor, and said carrier gas supply system is configured to introduce a second flow of said carrier gas to said process chamber through a by-pass gas line that by-passes said precursor evaporation system;
a carrier gas flow control system coupled to an output of said carrier gas supply system, and configured to control the amount of said first flow of said carrier gas and control the amount of said second flow of said carrier gas;
a film precursor vapor flow measurement system coupled to an inlet of said precursor evaporation system and an outlet of said precursor evaporation system, and configured to measure an amount of said film precursor vapor introduced to said first flow of said carrier gas; and
a controller coupled to said carrier gas flow control system and said film precursor vapor flow measurement system, wherein said controller is configured to compare said measured amount of said film precursor vapor to a target amount of said film precursor vapor, said controller is configured to adjust the amount of said first flow of said carrier gas such that said measured amount of said film precursor vapor is substantially equal to said target amount of said film precursor vapor, and said controller is configured to adjust the amount of said second flow of said carrier gas such that the total amount of said first flow of said carrier gas and said second flow of said carrier gas achieves a predetermined value.

17. A vapor delivery system configured to be coupled to a vapor deposition system and configured to introduce a film precursor vapor to a substrate within said vapor deposition system in order to form a thin film on said substrate from said film precursor vapor, comprising:
a precursor evaporation system configured to evaporate a film precursor to form said film precursor vapor;
a carrier gas supply system coupled to said process chamber and said precursor evaporation system, wherein said carrier gas supply system is configured to introduce a first flow of a carrier gas to said process chamber that passes through said precursor evaporation system and receives said film precursor vapor, and said carrier gas supply system is configured to introduce a second flow of said carrier gas to said process chamber through a by-pass gas line that by-passes said precursor evaporation system;
a carrier gas flow control system coupled to an output of said carrier gas supply system, and configured to control the amount of said first flow of said carrier gas and control the amount of said second flow of said carrier gas;
a film precursor vapor flow measurement system coupled to an inlet of said precursor evaporation system and an outlet of said precursor evaporation system, and configured to measure an amount of said film precursor vapor introduced to said first flow of said carrier gas; and
a controller coupled to said carrier gas flow control system and said film precursor vapor flow measurement system, wherein said controller is configured to compare said measured amount of said film precursor vapor to a target amount of said film precursor vapor, said controller is configured to adjust the amount of said first flow of said carrier gas such that said measured amount of said film precursor vapor is substantially equal to said target amount of said film precursor vapor, and said controller is configured to adjust the amount of said second flow of said carrier gas such that the total amount of said first flow of said carrier gas and said second flow of said carrier gas achieves a predetermined value.

18. The vapor delivery system of claim 17, further comprising:
a high flow conductance duct coupling said precursor evaporation system to said process chamber, wherein the flow conductance of said high flow conductance duct is greater than or equal to 50 liters per second.

19. The vapor delivery system of claim 17, wherein:
said carrier gas flow control system comprises:
a first mass flow controller configured to control the flow rate of said first flow of said carrier gas, and
a second mass flow controller configured to control the flow rate of said second flow of said carrier gas; and
said film precursor vapor flow measurement system comprises:
a first flow measurement device coupled to an inlet of said precursor evaporation system, and
a second flow measurement device coupled to an outlet of said precursor evaporation system,
wherein a difference between a first signal from said first flow measurement device and a second signal from said second flow measurement device is related to said amount of said film precursor vapor introduced to said first flow of said carrier gas.

20. The vapor delivery system of claim 19, wherein said precursor evaporation system, said first flow measurement device, and said second flow measurement device are controlled at an elevated temperature.

21. The vapor delivery system of claim 17, wherein:
said carrier gas flow control system comprises:
a mass flow controller configured to control the total flow rate of said first flow of said carrier gas and said second flow of said carrier gas,
a first valve having an inlet coupled to an output of said mass flow controller and an outlet coupled to said by-pass gas line, and
a second valve having an inlet coupled to said output of said mass flow controller and an outlet coupled to said precursor evaporation system,
wherein said first valve and said second valve are controllably operated in order to affect the fraction of the total flow rate of said carrier gas that passes through said precursor evaporation system as said first flow of said carrier gas and the remaining fraction of the total flow rate of said carrier gas that passes through said by-pass gas line as said second flow of said carrier gas; and
said film precursor vapor flow measurement system comprises:
a flow measurement device coupled to an outlet of said precursor evaporation system, and configured to measure the total flow rate of said first flow of said carrier gas, said second flow of said carrier gas and said film precursor vapor,
wherein a difference between a first signal from said flow measurement device and a second signal from said mass flow controller is related to said amount of said film precursor vapor introduced to said first flow of said carrier gas.

22. The vapor delivery system of claim 21, wherein said precursor evaporation system, and said flow measurement device are controlled at an elevated temperature.

23. The vapor delivery system of claim 21, wherein said first valve and said second valve comprise needle valves.

24. The vapor delivery system of claim 17, wherein said precursor vapor evaporation system is configured to evaporate a solid-phase film precursor.

25. The vapor delivery system of claim 17, wherein said precursor vapor evaporation system is configured to evaporate a liquid-phase film precursor.

26. The vapor delivery system of claim 17, wherein said precursor vapor evaporation system is configured to evaporate a metal-carbonyl precursor.

27. The vapor delivery system of claim 17, wherein said carrier gas supply system is configured to supply an inert gas.

28. The vapor delivery system of claim 17, wherein said carrier gas supply system is configured to supply a monoxide gas.

29. The vapor delivery system of claim 17, wherein said carrier gas supply system is configured to supply carbon monoxide (CO).

30. The vapor delivery system of claim 17, further comprising:
a dilution gas supply system coupled to said process chamber, and configured to introduce a dilution gas to said substrate in said process chamber.

31. The vapor delivery system of claim 30, wherein said dilution gas supply system is configured to introduce an inert gas.

32. The vapor delivery system of claim 30, wherein said dilution gas supply system is configured to introduce said dilution gas to a high flow conductance duct coupling said precursor evaporation system to said process chamber, wherein the flow conductance of said high flow conductance duct is greater than or equal to 50 liters per second.

33. A method of controlling a film precursor vapor in a vapor deposition system, comprising:
initiating a first flow of a carrier gas through a precursor evaporation system;
introducing said film precursor vapor to said first flow of said carrier gas in said precursor evaporation system;
initiating a second flow of said carrier gas that by-passes said precursor evaporation system;
measuring an amount of said film precursor vapor introduced to said first flow of said carrier gas;
comparing said amount of said film precursor vapor to a target amount of said film precursor vapor;
adjusting said first flow of said carrier gas through said precursor evaporation system such that said measured amount of said film precursor vapor is substantially equal to said target amount of said film precursor vapor;
adjusting said second flow of said carrier gas such that the total amount of said first flow of said carrier gas and said second flow of said carrier gas is substantially equal to a target amount; and
introducing said first flow of said carrier gas with said film precursor vapor, and said second flow of said carrier gas to said vapor deposition system.

34. The method of claim 33, further comprising:
adjusting said target amount of said film precursor vapor during a vapor deposition process.

35. The method of claim 33, further comprising:
adjusting said target flow rate of said carrier gas during a vapor deposition process.
